(19) United States
(12) Patent Application Publication
(10) Pub. No.: US 2026/0224088 A1
(43) Pub. Date: Aug. 6, 2026

(54) A DISHWASHER AND SUMP ARRANGEMENT THEREOF

(71) Applicant: ELECTROLUX APPLIANCES AKTIEBOLAG, Stockholm (SE)

(72) Inventors: Enrico PITTON, Porcia (IT); Mauro CINELLO, Porcia (IT); Luca GUIOTTO, Porcia (IT)

(73) Assignee: ELECTROLUX APPLIANCES AKTIEBOLAG, Stockholm (SE)

(21) Appl. No.: 19/154,409

(22) PCT Filed: Mar. 17, 2023
(86) PCT No.: PCT/EP2023/056929

§ 371 Date: Aug. 7, 2025

(51) Int. Cl. A47L 15/42; A47L 15/14; B01D 29/23; B01D 29/92; B01D 36/00; C02F 1/00; C02F 103/00

(52) U.S. Cl. CPC A47L 15/4225; A47L 15/14; A47L 15/4206; A47L 15/4223; B01D 29/23; B01D 29/92; B01D 36/00; C02F 1/001; C02F 2103/002; C02F 2301/046; C02F 2307/12

(57) ABSTRACT

A dishwasher including a washing chamber having a bottom wall, lateral walls, and an aperture for a closing door with a sump arranged at the bottom wall for receiving liquid and having an inner lateral wall extending around a sump axis and a bottom wall A circulating circuit including a circulating pump having an inlet hydraulically communicating with the sump recirculates liquid from the sump to a spray assembly. The inner lateral wall of the sump includes two or more apertures arranged around the sump axis and hydraulically communicating with the circulating pump inlet through at least one liquid channel that is delimited either by a first further lateral wall external to the inner lateral wall and the inner lateral wall or a first further lateral wall external to the inner lateral wall and a second further lateral wall external to the inner lateral wall.

### FIELD OF THE INVENTION

The present disclosure relates to a dishwasher, in particular to a sump arrangement of a dishwasher.

### BACKGROUND ART

A dishwasher is an apparatus for washing items using a force of washing liquid sprayed onto the items to be washed, which may be, for example, dishes, cutlery items and/or the like.

A dishwasher comprises a washing chamber, also referred to as a tub, closable by a door in which items to be washed are positioned, usually in racks.

Typically, dishwashers comprise one or more spray arms spraying washing liquid, e.g. a mixture of water and detergent, onto the items to wash them. Spray arms are typically rotatably mounted spray arms.

The washing liquid delivered by the spray arms during operation falls down and is collected in a lower part of the tub, also known as sump.

A circulating circuit is firstly associated to the sump which recirculates the washing liquid to the spray arms. The circulating circuit typically comprises a circulating pump having an inlet hydraulically communicating with the sump.

The inlet is typically connected to a circumferential side of the sump and an outlet of the circulating pump is preferably connected to a distributing element, also known as flow controller, that determines which spray arm has to be fed with the washing liquid. Thus, by configuring the distributing element in a particular way the washing liquid can be pumped by the circulating pump to be sprayed via a determined set of spray arms.

The sump is preferably covered by a removable flat filter blocking debris during operation.

According to known systems, the inlet of the circulating pump comprises a connection piece which is integrally made with a side wall of the sump, preferably obtained through an injection-moulded process.

Liquid recirculated through the circulating circuit is preferably further subjected to a filtration and a filtering group is preferably arranged upstream the circulation pump. Known filtering groups comprise a substantially cylindrical filter element arranged in the sump. Liquid coming from the tub flows through the filter element reaching an annular cylindrical chamber defined between the circumferential side of the sump and the filter element. From the annular chamber the liquid is then circulated to the spray arms through the circulating pump.

The filter element is preferably removably arranged in the sump so that it can be removed to be periodically cleaned and/or substituted.

A draining circuit is further associated to the sump which drains washing liquid outside the dishwasher up to a drainage point, in particular at the end of a washing program. The draining circuit typically comprises a draining pump having an inlet hydraulically communicating with the bottom of the sump. The inlet of the draining pump preferably directly communicates with the inner side of the cylindrical filter element, when provided.

Hence debris, like food residues and/or other contaminations, blocked by the filter element fall onto the bottom of the sump and from there discharge to the outside, preferably at the end of the washing program.

Preferably, the draining pump comprises a rotatable impeller received in a suction chamber communicating with the bottom of the sump through said inlet and wherein at least part of the housing of the suction chamber is integrally formed with the sump.

Known system preferably comprises a removable member arranged at the inlet of the draining pump, also indicated as a pump cover, accessible to a user from the interior of the sump that gives access to the suction chamber and to the impeller. The pump cover may be advantageously removed in case the impeller within the suction pump gets clogged for allowing cleaning operations by the user.

It is an aim of manufacturers keeping the efficiency of the recirculating operations as higher as possible. This may lead to a reduced energy and/or water consumption. The efficiency of the recirculating operations is either affected by the efficiency of the filtration process or the efficiency of the circulating pump.

Efficiency of the filtration process is linked to the degree of obstruction of the filtering group arranged upstream the circulation pump.

Efficiency of the circulating pump is linked to the liquid level into the sump, in particular the liquid level at the inlet of the circulating pump, that would avoid intake of air at the circulating pump.

It is therefore an object of the invention to provide a solution that increases the efficiency of the filtration process compared to known systems.

A further object of the present invention is to provide a dishwasher that increases the efficiency of the recirculating operations compared to known systems.

### DISCLOSURE OF THE INVENTION

Applicant has found that by providing a dishwasher comprising a washing chamber and a sump arranged at a bottom wall of the washing chamber and comprising a circulating pump having an inlet hydraulically communicating with the sump and by providing the inner wall of the sump with two or more apertures hydraulically communicating with the circulating pump inlet through at least one liquid channel, it is possible to reach the mentioned objects.

In an aspect thereof the present invention relates, therefore, to a dishwasher for washing items comprising:
a washing chamber comprising a bottom wall, lateral walls and an aperture for a closing door;
one or more racks for said items to be washed;
at least one spray assembly for spraying liquid onto said items placed in said one or more racks;
a sump arranged at said bottom wall of said washing chamber for receiving liquid from said washing chamber, said sump comprising an inner lateral wall extending around a sump axis and a bottom wall;
a circulating circuit associated to said sump to recirculate liquid from said sump to said at least one spray assembly, wherein said circulating circuit comprises a circulating pump having an inlet hydraulically communicating with said sump;
a filtering group received in said sump and hydraulically arranged upstream said circulating pump for filtering liquid flowing from said sump to said circulating pump;
a draining circuit associated to said sump to drain liquid outside said dishwasher, wherein said draining circuit comprises a draining pump having an inlet hydraulically communicating with said sump;
wherein said inner lateral wall of said sump comprises two or more apertures arranged around said sump axis and hydraulically communicating with said circulating pump inlet through at least one liquid channel, wherein said at least one liquid channel is delimited either by:
a first further lateral wall of said sump and said inner lateral wall, wherein said first further lateral wall is external to said inner lateral wall so that said inner lateral wall is arranged between said first further lateral wall and said sump axis; or
a first further lateral wall of said sump and a second further lateral wall of said sump, wherein said first further lateral wall is external to said inner lateral wall and said second further lateral wall is external to said inner lateral wall so that said inner lateral wall is arranged between said first further lateral wall and said sump axis and said first further lateral wall is arranged between said second further lateral wall and said inner lateral wall.

In the installed position of the dishwasher, the sump is arranged so that the sump axis is preferably aligned to the vertical direction.

In a preferred embodiment, the two or more apertures are distributed around the sump axis over a sector having an angle greater than 90°, preferably over a sector having an angle greater than 120°, more preferably over a sector having an angle greater than 150°, still more preferably over a sector having an angle greater than 180°.

Advantageously, the flow of liquid that passes through the filtering group and that reaches the apertures is distributed over the sector where the apertures are arranged. The filtration is advantageously distributed homogeneously around the filtering group.

Still advantageously, apertures distributed around the sump axis allow the upper liquid surface of the liquid inside the sump to be closer to an ideal horizontal surface thus avoiding cavitation for the circulating pump and maintaining the liquid inside the sump at the lowest level is possible thus reducing liquid consumption.

According to a preferred embodiment, the two or more apertures have sizes that vary in relation to their position around the sump axis.

The size of an aperture is intended as the cross-section area of the aperture through which the liquid may flow.

Preferably, a first aperture of the two or more apertures is arranged close to the circulating pump inlet and a second aperture of the two or more apertures is arranged opposite the first aperture with respect to the sump axis.

In a preferred embodiment, the inner lateral wall comprises a first aperture of the two or more apertures, a second aperture of the two or more apertures and one or more further apertures arranged between the first aperture and the second aperture, wherein the first and second apertures have maximum size and the one or more further apertures have sizes decreasing moving away from the first and second apertures.

According to a preferred embodiment, the sector comprises a first sub-sector and a second sub-sector, wherein the first sub-sector comprises at least one aperture, having a first size, of the two or more apertures, and the second sub-sector comprises at least one aperture, having a second size, of the two or more apertures, wherein the first size is greater than the second size.

Preferably, the sector comprises a third sub-sector comprised between the first sub-sector and the second sub-sector, wherein the third sub-sector comprises at least one aperture, having a third size, of the two or more apertures, wherein the third size is less than the first size and/or less than the second size.

Advantageously, the distribution around the filter axis of the liquid flowing towards the liquid channel is optimized. Still advantageously, the liquid flow speed of the liquid flowing through the liquid channel is optimized and the liquid flow has reduced turbulences.

According to a preferred embodiment, the two or more apertures feed a single common liquid channel of the at least one liquid channel.

According to a further preferred embodiment, the at least one liquid channel comprises a plurality of separated liquid channels and the two or more apertures feed said separated liquid channels.

In a preferred embodiment, the draining pump inlet is connected at the bottom of the sump.

Advantageously, liquid is efficiently discharged to the outside, preferably at the end of a washing program.

Preferably, the filtering group is removably arranged in the sump.

Advantageously, the filtering group can be easily removed to be periodically cleaned and/or substituted.

In a preferred embodiment, the filtering group comprises at least a filter element, said at least a filter element comprising a tubular filtering surface wherein the tubular filtering surface delimits an inner volume apt to receive liquid coming from the tub.

Preferably, the draining pump inlet directly communicates with the inner volume of the tubular filtering surface.

According to a preferred embodiment, the inner lateral wall of the sump is cylindrically shaped so that the inner lateral wall shows a circular cross-section considering a section plan which is perpendicular to the sump axis.

Advantageously, manufacturing of the sump is simplified.

Preferably, the circulating pump inlet comprises a tubular connection duct extending around a connection axis and the tubular connection duct is oriented in such a way that the projection towards the sump axis of the tubular connection duct along a direction parallel to the connection axis does not enclose/encompass the sump axis.

According to this arrangement, the circulating pump is therefore preferably connected to the sump according to a tangential configuration.

Advantageously, the circulating pump is mounted in a space-saving manner that reduces encumbrance.

In a preferred embodiment, the draining pump inlet comprises a tubular connection duct extending around a connection axis and the tubular connection duct is oriented in such a way that the projection towards the sump axis of the tubular connection duct along a direction parallel to the connection axis encloses/encompasses the sump axis.

According to this arrangement, the draining pump is therefore preferably connected to the sump according to a radial configuration.

According to a preferred embodiment, the circulating pump and the draining pump are both arranged at the same side with respect to a bisecting plane passing through the sump axis, wherein the side corresponds to the rear side of the dishwasher.

Advantageously, said pumps arrangement allows reduced cabling complexity and/or cabling costs and/or overall noise level.

In a preferred embodiment, the bottom wall of the washing chamber receives a flat filter device to block debris before they reach the sump while liquid may pass therethrough.

In a further aspect the present invention relates to a dishwasher for washing items comprising:
a washing chamber comprising a bottom wall, lateral walls and an aperture for a closing door;
one or more racks for said items to be washed;
at least one spray assembly for spraying liquid onto said items placed in said one or more racks;
a sump arranged at said bottom wall of said washing chamber for receiving liquid from said washing chamber, said sump comprising an inner lateral wall extending around a sump axis and a bottom wall;
a flat filter device received in said bottom wall of said washing chamber to block debris before they reach said sump while liquid may pass therethrough;
a draining circuit associated to said sump to drain liquid outside said dishwasher, wherein said draining circuit comprises a draining pump having an inlet hydraulically communicating with said sump, said draining pump comprising a suction chamber receiving a rotatable impeller wherein said suction chamber is defined by a housing at least partially formed with said sump and said housing comprises an inspection aperture facing the interior of said sump;
a removable cover member removably associated to said inspection aperture; wherein said removable cover member comprises a first portion apt to close said inspection aperture when said removable cover member is in its working position and a second portion extending from said first portion and towards said flat filter device so that said second portion contacts the lower surface of said flat filter device when said flat filter device is being positioned in its working position.

Advantageously, a user may have access to the suction chamber and the impeller through the inspection aperture and intervene in case the draining pump gets clogged and cleaning operations are required.

In a preferred embodiment, the removable cover member is removably associated to the inspection aperture through a snap-in device.

According to a preferred embodiment, the second portion of the cover member comprises two side arms and a transversal arm connecting the two side arms.

Preferably, the dishwasher further comprises:
a circulating circuit associated to the sump to recirculate liquid from the sump to the at least one spray assembly, wherein the circulating circuit comprises a circulating pump having an inlet hydraulically communicating with the sump;
a filtering group received in the sump and hydraulically arranged upstream the circulating pump for filtering liquid flowing from the sump to the circulating pump.

In a preferred embodiment, the filtering group is removably arranged in the sump. Advantageously, the filtering group can be easily removed to be periodically cleaned and/or substituted.

According to a preferred embodiment, the filtering group comprises at least a filter element, said at least a filter element comprises a tubular filtering surface wherein the tubular filtering surface delimits an inner volume apt to receive liquid coming from the tub.

### BRIEF DESCRIPTION OF THE DRAWINGS

Further characteristics and advantages of the present invention will be highlighted in greater detail in the following detailed description of preferred embodiments, provided with reference to the enclosed drawings. In particular:

FIG. 1 shows a front view of a dishwasher according to a preferred embodiment of the invention;

FIG. 2 is a schematic cross-sectional side view of the dishwasher of FIG. 1 showing the washing chamber thereof;

FIG. 3 shows a perspective view of the bottom part of the dishwasher of FIG. 2;

FIG. 4 shows an exploded view of some components of FIG. 3;

FIG. 5 shows a vertical cross-sectional view of FIG. 3;

FIG. 6 shows a cross-sectional view of an enlarged detail of FIG. 4;

FIGS. 6A and 6B shows the cross-sectional view of FIG. 6 from different point of views;

FIG. 7 shows a perspective view from below of the bottom part of the dishwasher of FIG. 2;

FIG. 7A shows a partially exploded view of FIG. 7;

FIG. 8 shows a plan view of FIG. 7;

FIG. 9 shows a plan cross-sectional view of FIG. 6;

FIG. 10 shows a perspective view of a sump with a cover member according to a preferred embodiment of the invention;

FIG. 11 shows the sump of FIG. 10 with the cover member removed therefrom;
FIG. 12 shows a perspective view of the cover member of FIG. 10 isolated from the rest;
FIG. 13 the cover member of FIG. 12 from another point of view;
FIG. 14 shows a cross-sectional view of FIG. 10 with the pump cover in a first operating position;
FIG. 15 shows a cross-sectional view of FIG. 10 with the pump cover in a second operating position;
FIG. 16 shows a further embodiment of FIG. 9;
FIG. 17 shows another embodiment of FIG. 9;
FIG. 18 shows a further embodiment of FIG. 9.

### DETAILED DESCRIPTION OF PREFERRED EMBODIMENTS OF THE INVENTION

Aspects of the present invention will now be described more fully. Well-known functions or constructions will not necessarily be described in detail for brevity and/or clarity.

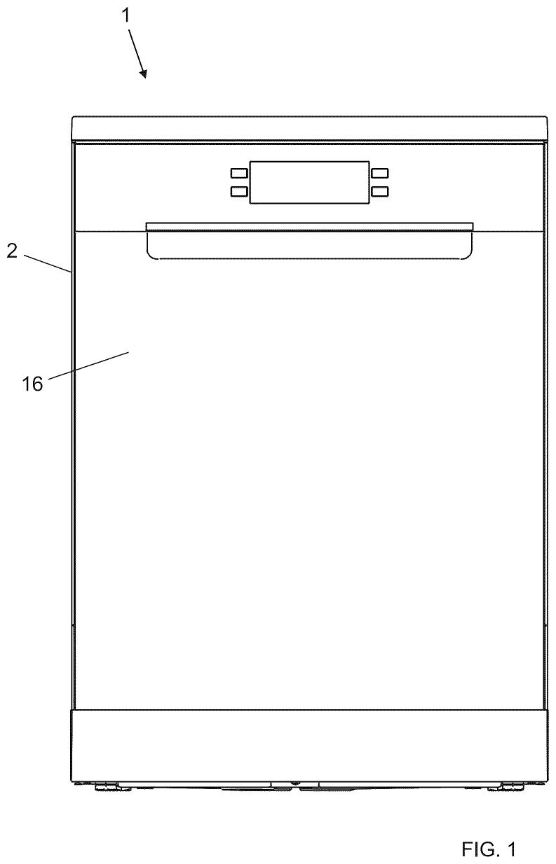

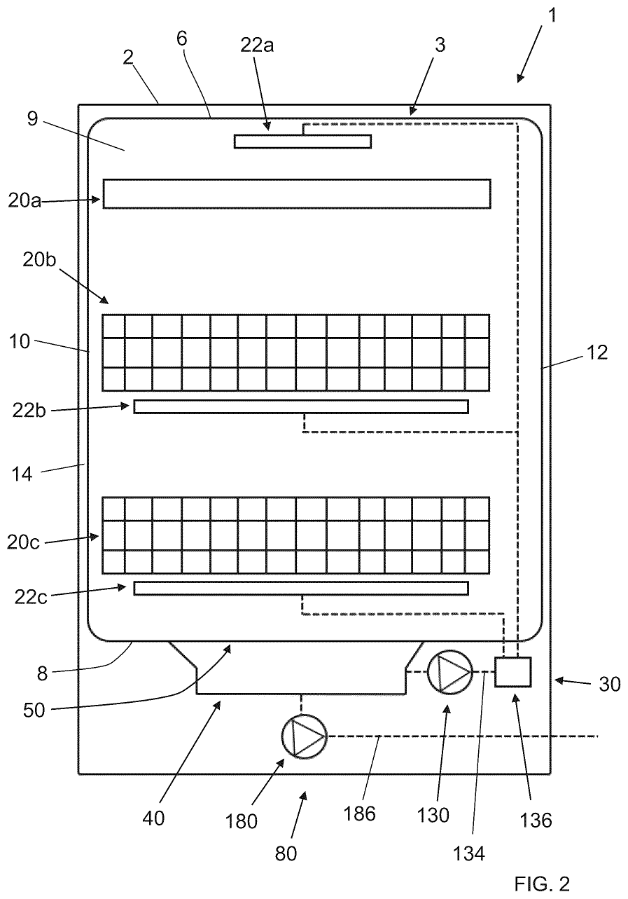

FIGS. 1 and 2 illustrate a dishwasher 1 according to a preferred embodiment of the present disclosure. The dishwasher 1 comprises an outer cabinet 2 and a washing chamber 3 configured to accommodate items to be washed, such as dishware, cutlery, and the like.

A number of walls form the washing chamber 3, hereinafter also indicated as tub 3. The tub 3 preferably comprises a top wall 6, a bottom wall 8, a rear wall 9, lateral walls 10, 12 and an aperture 14. The aperture 14 allows access to the tub 3 and a closing door 16 is associated to the aperture 14.

The dishwasher 1 comprises one or more racks 20a, 20b, 20c apt to accommodate said items, such as dishware, cutlery, and the like. An uppermost rack 20a is typically arranged to accommodate cutlery and is also known as a top cutlery tray 20a, a lower rack 20c and an intermediate rack 20b are the typically arranged one above the other wherein each rack 20c, 20b is configured to accommodate specific items to be washed, for example the lower rack 20c configured to receive dishes or pots and the intermediate rack 20b configured to receive mugs or glasses.

Racks 20a, 20b, 20c are preferably slidingly arranged in the tub 3 which facilitate loading and unloading of items into and out of the racks 20a, 20b, 20c.

The dishwasher 1 further preferably comprises a lower spray arm assembly 22c rotatably mounted within a lower region 3a of the tub 3 close to the bottom wall 8 thereof and below the lower rack 20c and a mid-level rotatable spray arm assembly 22b located in close proximity and below the intermediate rack 20b. Additionally, an upper spray assembly 22a is preferably located above the uppermost rack 20a. Spray assemblies 22a, 22b, 22c force washing or rinsing liquid onto items in the racks 20a, 20b, 20c. A circulating circuit 30 feeds liquid to the spray assemblies 22a, 22b, 22c, as better described later.

With the term liquid we will refer hereinafter generally to any liquid that may flow inside the dishwasher 1, for example washing liquid constituted of water and detergent or rinse liquid constituted of clean water.

At the bottom wall 8 of the tub 3 there is provided a sump 40 in which liquid is collected by gravity.

The sump 40 protrudes downwardly from the bottom wall 8 and preferably has a substantially cylindrical shape. Advantageously, manufacturing of the sump 40 is simplified.

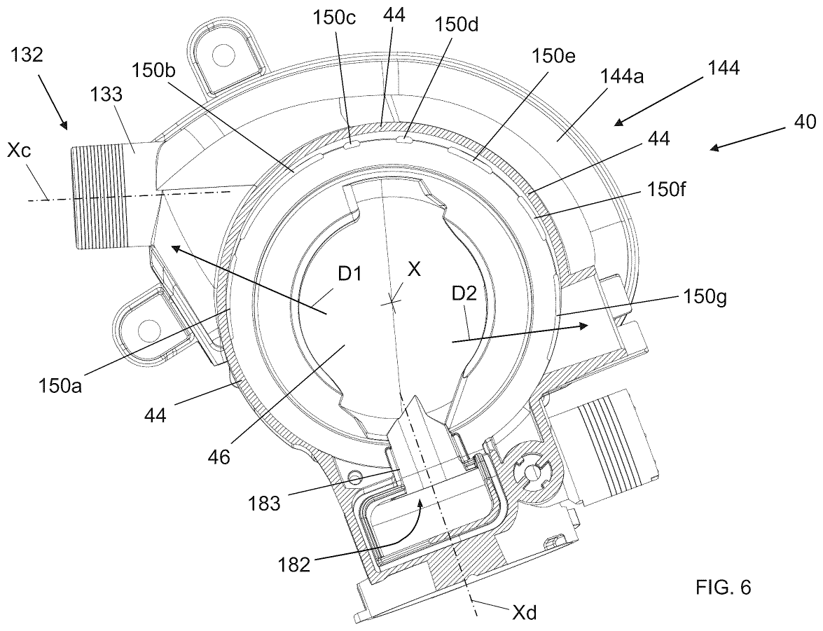

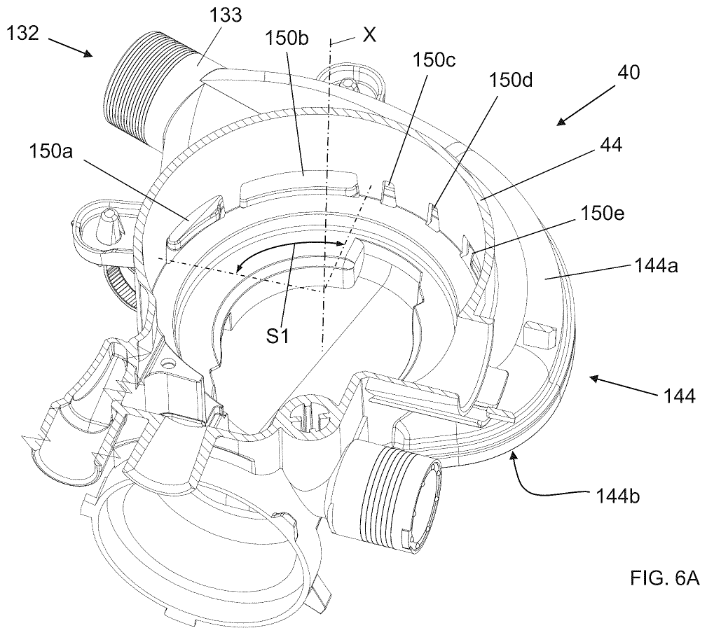

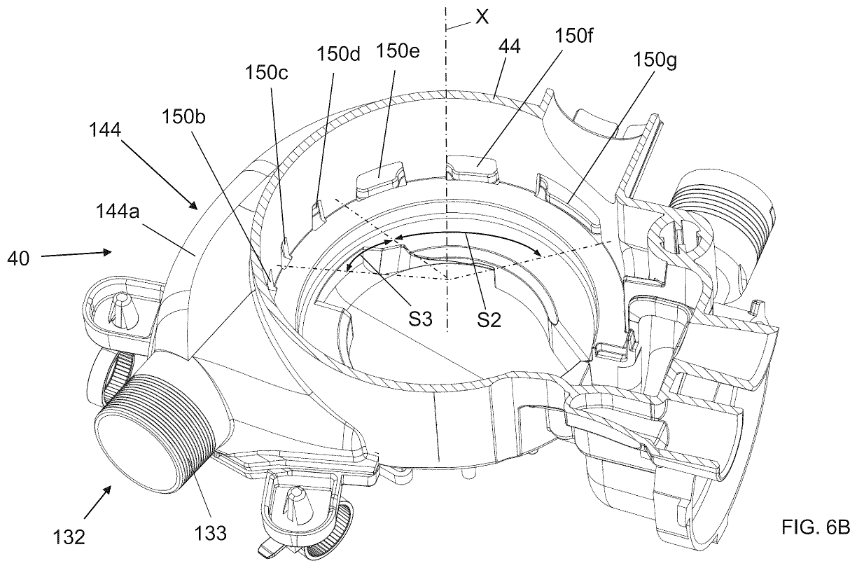

The sump 40 preferably comprises side walls 44, 46, more preferably comprises an inner lateral wall 44 and a bottom wall 46. The inner lateral wall 44 preferably extends along a sump axis X, more preferably extends along the sump axis X and is cylindrically shaped, or substantially cylindrically shaped. Therefore, preferably, the inner lateral wall 44 of the sump 40 shows a circular cross-section considering a section plan which is perpendicular to the sump axis X, as better visible in FIGS. 6, 6A, 6B.

The sump 40 is opportunely configured so that the sump axis X substantially corresponds to the vertical direction when the dishwasher 1 is in the installed position.

Liquid collected in the sump 40 is used for washing items through said circulating circuit 30 or is discharged to the outside, preferably at the end of the washing program, through a draining circuit 80.

The bottom wall 8 of the tub 3 preferably receives a flat filter device 50 to block debris before they reach the sump 40 while liquid may pass therethrough.

The flat filter device 50 preferably comprises a first flat filter 52 and a second flat filter 54 arranged side by side. First and second flat filters 52, 54 are preferably received in a swallow portion 42 of the bottom wall 8 of the tub 3.

The first filter 52 preferably comprises apertures with predetermined size, for example 0.8 mm-diameter cylindrical holes. The first filter 52 is preferably made with plastic material. The first filter 52 is preferably removably fixed to the bottom wall 8 of the tub 3 by means of screws 56.

The second filter 54 preferably comprises a mesh, preferably realized with a woven wire, which is chosen to have a mesh size configured to retain particles having a dimension higher than 1 mm. The second filter 54 is preferably removably arranged at the bottom wall 8 of the tub 3, as better described later.

According to an aspect of the invention, a filtering group 100 is arranged in the sump 40 and preferably the filtering group 100 is removably arranged in the sump 40. Advantageously, the filtering group 100 can be easily removed to be periodically cleaned and/or substituted.

Filtering groups are known in the art and one preferred embodiment will be described hereinafter.

The filtering group 100 preferably comprises an inner filter element 102 and an outer filter element 103 arranged one inside the other. The inner filter element 102 and the outer filter element 103 are preferably coaxially arranged one inside the other. The inner filter element 102 is preferably a coarse filter element 102 apt to stop coarse objects and the outer filter element 103 is preferably a fine filter element 103 for a finer filtration process. The outer filter element 103 delimits an inner volume 108.

The inner filter element 102 preferably comprises a top portion 104 that the user can grasp to preferably remove the filtering group 100 from the sump 40.

The inner filter element 102 has a filtering surface 106. The filtering surface 106 is preferably a tubular filtering surface, more preferably a cylindrical tubular filtering surface 106.

The filtering surface 106 delimits an inner volume receiving liquid coming from the tub 3. At this purpose, the top portion 104 of the filter element 102 has inlet openings 111 allowing liquid flowing/falling from the tub 3 to the inner volume of the inner filter element 102.

The filtering surface 106 preferably comprises a plurality of apertures 106a, more preferably rectangular apertures 106a, so as to form a net.

The inner filter element 102 preferably has a connecting device 110 for removably connecting the inner filter element 102 to the sump 40. The connecting device 110 preferably comprises one or more tongues with teeth 112 that engage respective retention surfaces 114 realized in the bottom of the sump 40.

The filtering group 100 is therefore preferably removably associated to the sump 40 through a bayonet connection and respective bayonet movement.

In further preferred embodiments, the filtering group may be configured to be removably coupled to the sump differently, for example by a snap-in device.

The outer filter element 103 has a filtering surface 107. The filtering surface 107 is preferably a tubular filtering surface, more preferably a cylindrical tubular filtering surface 107.

The filtering surface 107 preferably comprises a plurality of meshes 107a, more preferably rectangular meshes 107a. Meshes 107a are preferably realized with a woven wire. In a preferred embodiment the wire is made of polyethylene. Said plurality of meshes 107a can be provided by one or more layers of woven wire covering a plurality of openings formed in walls of the outer filter element 103. In particular, said walls can be formed by over-injecting a polymeric material on a mesh foil.

Preferably, the mesh is chosen to have a mesh size of 0.315 mm.

In different preferred embodiments, the mesh is chosen to have a proper mesh size according to the fine filtration quality required.

The filtering group 100 preferably extends along a filter axis X1. In the preferred embodiment described herein, the filter axis X1 preferably coincides with, or is parallel to, the sump axis X, considering the filtering group 100 in its installed position.

Preferably, the inner filter element 102 extends along the filter axis X1 and the outer filter element 103 extends along the filter axis X1 and the filter elements 102, 103 are therefore coaxial.

According to the preferred embodiment illustrated and described herein, the filtering group 100 comprises two filter elements 102, 103, i.e. the inner filter element 102 and the outer filter element 103. In other preferred embodiments, nevertheless, the filtering group may comprise a different number of filter elements, for example more than two filter elements or even a single filter element. A gap 60 is formed between the filtering group 100 and the inner lateral wall 44 of the sump 40, preferably between the outer filter element 103 and the inner lateral wall 44 of the sump 40. Such gap 60 receives filtered liquid exiting the filtering group 100. The gap 60 further receives filtered liquid passing through, and falling from, the flat filter device 50, preferably passing through the first and second flat filters 52, 54.

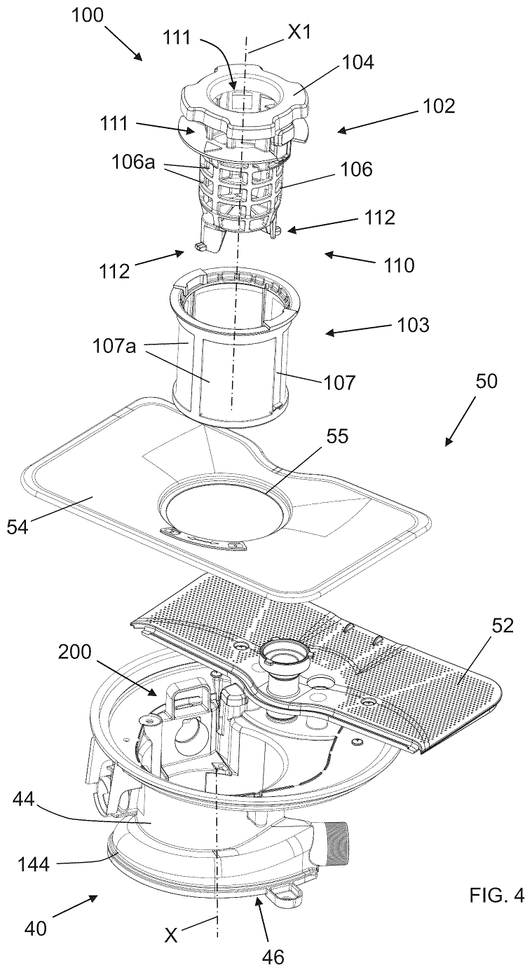

According to the preferred embodiment illustrated and described herein, the second flat filter 54 is preferably connected to the filtering group 100 so that the second flat filter 54 and the filtering group 100 move together, in particular when the filtering group 100 is removed from the sump 40. On the other hand, the second flat filter 54 is maintained in position by the filtering group 100 when the latest is installed into the sump 40 and stably connected thereto. The filtering group 100 is preferably received in a hole 55 of the second flat filter 54, as visible in FIG. 4. According to an aspect of the invention, the circulating circuit 30 that feeds liquid to the spray assemblies 22a, 22b, 22c is associated to the sump 40 and comprises a circulating pump 130 having an inlet 132 hydraulically communicating with the sump 40 and an outlet 134 hydraulically communicating with the spray assemblies 22a, 22b, 22c.

The circulating pump inlet 132 preferably comprises a connection piece 133, more preferably a tubular connection duct 133, that extends around a connection axis Xc. Sill more preferably the connection piece 133 comprises a tubular cylindrical connection duct 133.

The circulating pump inlet 132 is preferably integrally made with the sump 40.

Preferably, the outlet 134 of the circulating pump 130 is connected to a distributing element 136, also known as flow controller 136, that determines which spray assembly 22a, 22b, 22c has to be fed with the liquid. Thus, by configuring the distributing element 136 in a particular way the washing liquid can be pumped by the circulating pump 130 to be sprayed via a determined set of spray assembly.

The distributing element of a dishwasher is well known in the art, and therefore it will not be described in detail.

Therefore, after passing through the filtering group 100 and/or the flat filter device 50, filtered liquid eventually travels to the circulating pump inlet 132 and then returned to the tub 3 by the circulating pump 130 through the distributing element 136 and the spray assemblies 22a, 22b, 22c.

In particular, after passing through the filtering group 100 and/or the flat filter device 50, filtered liquid is received in the gap 60 and from the gap 60 sucked by the circulating pump 130.

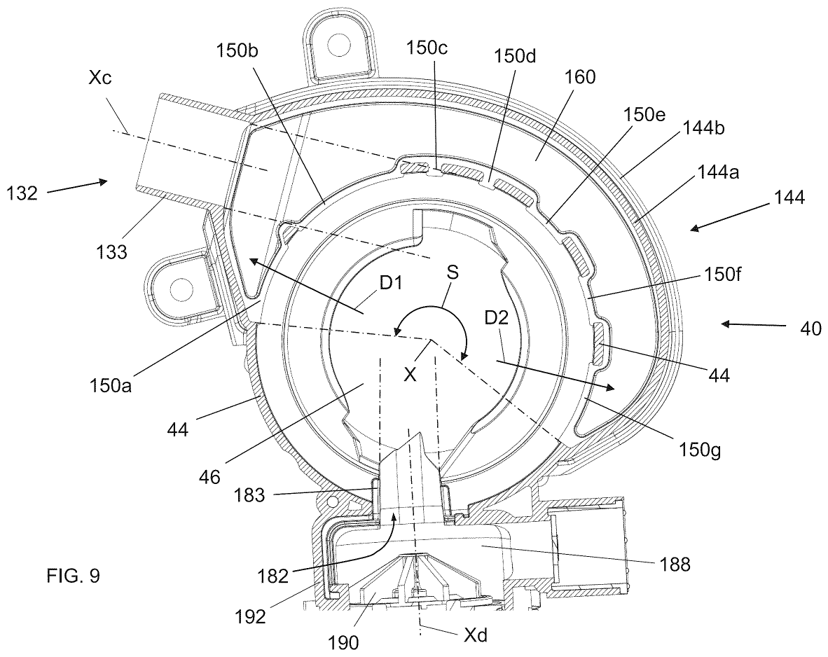

According to an aspect of the invention, the inner lateral wall 44 of the sump 40 comprises apertures 150a-150g arranged around the sump axis X, as shown in FIG. 9, wherein the apertures 150a-150g hydraulically communicate with the pump inlet 132 through a liquid channel 160.

The liquid channel 160 is externally delimited by a further lateral wall 144 of the sump 40, wherein the further lateral wall 144 is external to the inner lateral wall 44 of the sump 40. The further lateral wall 144 is external to the inner lateral wall 44 of the sump 40 so that the inner lateral wall 44 is arranged between the first further lateral wall 144 and the sump axis X.

The further lateral wall 144 preferably extends around the inner lateral wall 44, more preferably extends around a portion of the inner lateral wall 44. The further lateral wall 144 is preferably curved shaped around the inner lateral wall 44.

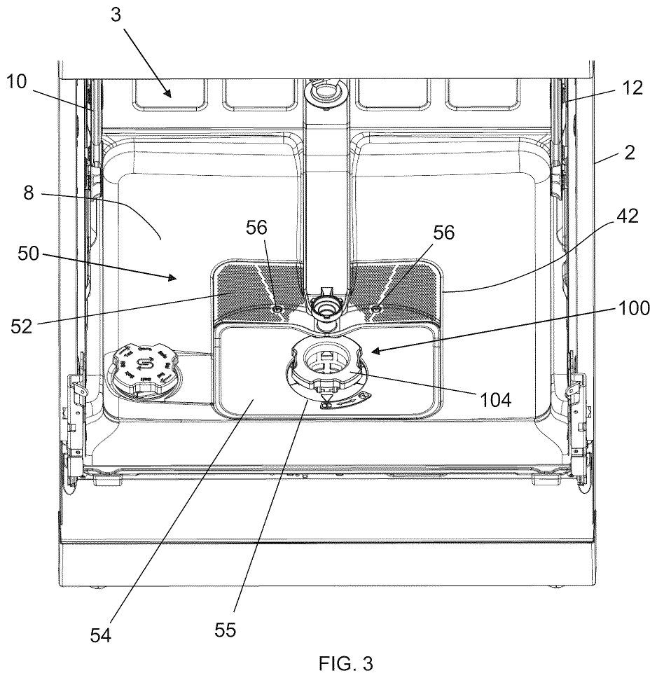

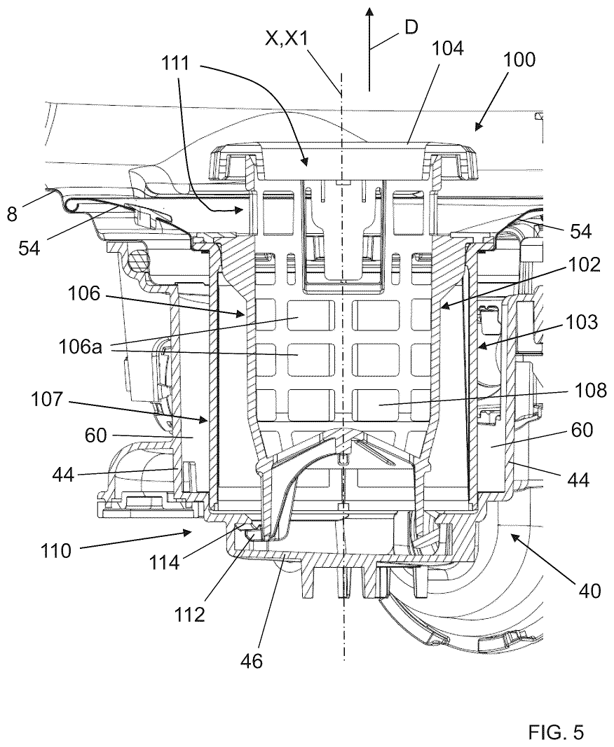

According to the preferred embodiment shown in FIG. 1 to 15, the further lateral wall 144 preferably comprises an upper portion 144a and a lower portion 144b. The upper portion 144a of the further lateral wall 144 is preferably integrally made with the sump 40. More preferably, the upper portion 144a of the further lateral wall 144 is integrally made with the inner lateral wall 44 of the sump 40, as better visible in FIGS. 6A and 6B.

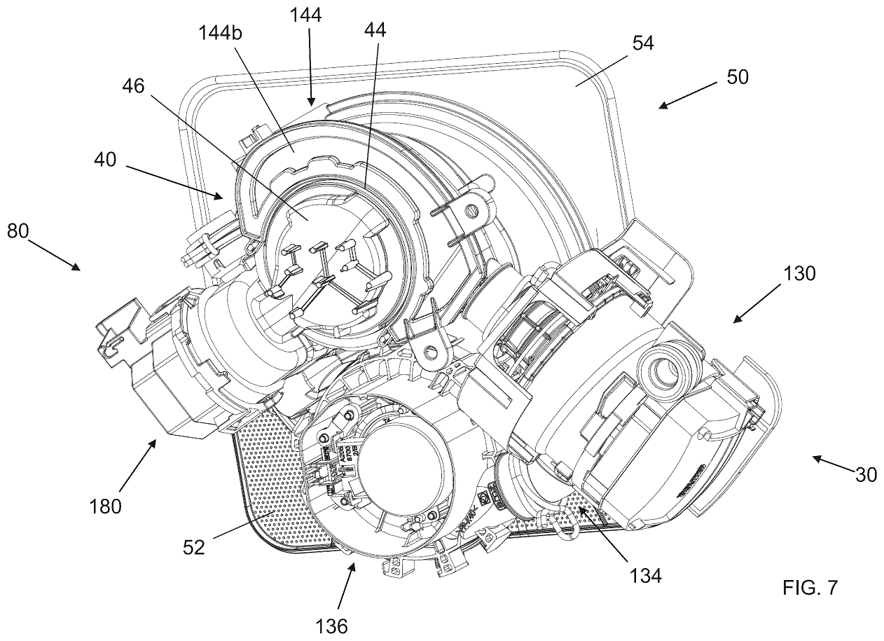

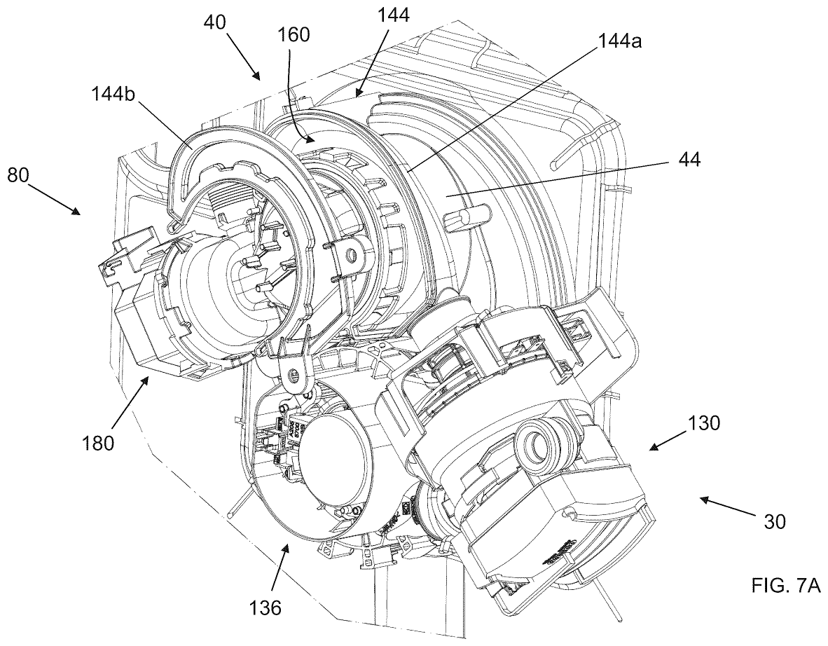

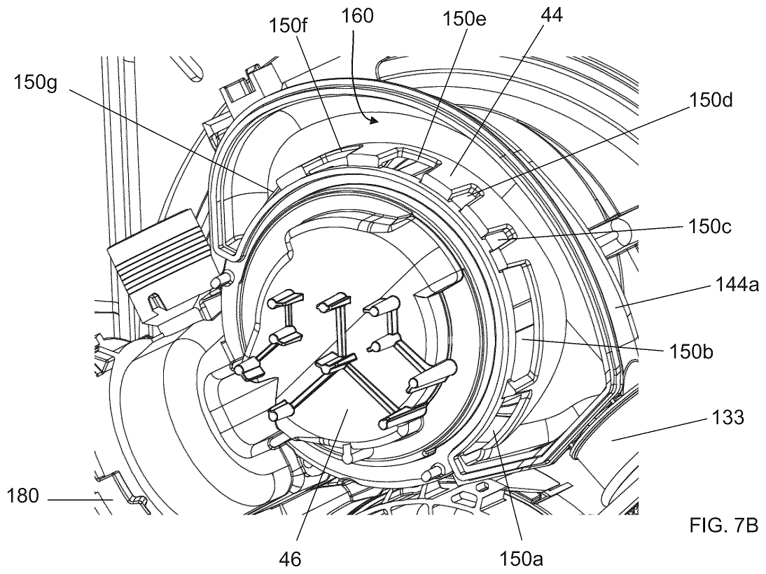

The lower portion 144b of the further lateral wall 144 is preferably embodied as a separate part, as visible in FIG. 7A, which is fixedly connected to the upper portion 144a, for example through a welding process. The lower portion 144b is preferably planar.

The liquid channel 160 is therefore preferably externally delimited by the upper and lower portions 144a, 144b of the further lateral wall 144.

The liquid channel 160 is preferably configured to embrace all the apertures 150a-150g. The liquid channel 160 preferably extends as a curved channel around the inner lateral wall 44 of the sump 40.

The liquid channel 160 is advantageously fed with liquid through said apertures 150a-150g, that represent respective inlets for the liquid channel 160, and ends at the circulating pump inlet 132, that represents the outlet for the liquid channel 160. In particular, the liquid from the gap 60 flows through the apertures 150a-150g and feeds the liquid channel 160.

According to the preferred embodiment illustrated and described herein, there are provided seven apertures 150a-150g arranged around the sump axis X and occupying a predetermined sector S of circle.

The first aperture 150a is preferably arranged close to the circulating pump inlet 132 and other apertures 150b-150g are preferably arranged in a direction away from the pump inlet 132. Preferably, the last aperture 150g is substantially arranged opposite the first aperture 150a with respect the sump axis X in the inner lateral wall 44. The sector S with said apertures 150a-150g preferably has an angle around 210°. Apertures 150 a-150g preferably have a substantially rectangular shape.

Advantageously, the liquid from the gap 60 reaches the liquid channel 160 by flowing through apertures 150a-150g which are distributed over a selected sector S. In particular, as depicted in FIG. 9, the liquid from the gap 60 reaches the liquid channel 160 flowing through the first aperture 150a substantially along a first direction D1 and hence immediately reaches the circulating pump inlet 132; the liquid from the gap 60 reaches the liquid channel 160 flowing through the last aperture 150g and substantially along a second direction D2 that is substantially opposite, with respect the sump axis X, the first direction D1; the liquid from the gap 60 reaches the liquid channel 160 flowing through the reaming apertures 150b-150f along respective directions that are angularly distributed around the sump axis X within the predetermined sector S.

An effect of the apertures 150a-150g is that of defining respective suction areas of liquid from the gap 60 that are arranged around the filtering group 100, preferably arranged around the outer filter element 103.

The flow of liquid that passes through the outer filter element 103 and that reaches the apertures 150a-150g is distributed over the sector S where the suction apertures 150a-150g are arranged.

Therefore, advantageously, the effective filtering surface 107 of the outer filter element 103 subjected to filtration is distributed around the filter axis X1 unlike known systems wherein liquid is typically sucked from a single aperture and hence liquid substantially flows in a restricted area.

The outer filter element 103, with its filtering surface 107, thus works in a more efficient way compared to known systems since filtration is distributed more homogeneously over the filtering surface 107 and not concentrated in a small area. This leads to a reduction of maintenance and/or increases lifetime of the filtering group 100.

Apertures 150a-150g have respective sizes that preferably vary in relation to their position around the sump axis X.

The size of an aperture is intended as the cross-section area of the aperture through which the liquid may flow.

Preferably, first and last apertures 150a and 150g have maximum size and adjacent apertures 150b-150f have sizes decreasing moving away from the first and last apertures 150a and 150g.

Preferably, as depicted in FIG. 6A, a first number of apertures are arranged around the sump axis X to occupy a first predetermined sub-sector S1 of said sector S, for example the first and second apertures 150a, 150b occupy the first sub-sector S1.

Still preferably, as depicted in FIG. 6B, a second number of apertures are arranged around the sump axis X to occupy a second predetermined sub-sector S2 of said sector S, for example the fifth to seventh apertures 150e-150g occupy the second sub-sector S2.

Still preferably, as depicted in FIG. 6B, a third number of apertures are arranged around the sump axis X to occupy a third predetermined sub-sector S3 of said sector S, for example third and fourth apertures 150c, 150d occupy the third sub-sector S3.

The sub-sectors S1, S2, S3 are preferably adjacent one to the other. The third sub-sector S3 is preferably comprised between the first sub-sector S1 and the third sub-sector S3.

The apertures 150a, 150b occupying the first sub-sector S1 preferably have respective sizes that are greater than the sizes of the remaining apertures.

The apertures 150e-150g occupying the second sub-sector S2 preferably have respective sizes that are less than the sizes of the apertures of the first sub-sector S1.

The apertures 150c-150d occupying the third sub-sector S3 preferably have respective sizes that are less than the sizes of the apertures of the first sub-sector S1 and/or of the second sub-sector S2.

Experiments have revealed that this sizes configuration of the apertures 150a-150g optimizes the distribution around the filter axis X1 of the liquid from the gap 60 towards the liquid channel 160, optimizes the liquid flow speed of the liquid flowing through the liquid channel 160 and optimizes the liquid flow in terms of reduced turbulences.

Furthermore, an issue relating the circulating pump 130 is that of avoid cavitation caused by air or air bubbles drawn from its inlet 132. In dishwasher, cavitation is prevented by maintaining the liquid level higher than the inlet 132 of the circulating pump 130 that means maintaining the liquid column inside the sump 40 above a minimum threshold.

On the other side to obtain a water saving, the liquid received inside the sump 40 that is recirculated to wash items is preferably maintained at the lowest level is possible.

This goal is advantageously reached by the proposed solution wherein apertures 150a-150g distributed over the sector S allow the upper liquid surface of the liquid inside the sump 40 to be closer to an ideal horizontal surface, in particular compared to a single suction aperture as in prior art systems.

The more the upper liquid surface is close to an ideal horizontal surface, the lower is the liquid required to avoid cavitation and hence the lower is the liquid/water consumption.

In the preferred embodiment illustrated and described above, there are seven rectangular apertures 150 a-150g distributed around the sump axis X over a 210° sector S.

Preferably, apertures 150a-150g according to the invention are distributed around the sump axis X over a sector S having an angle greater than 90°, preferably over a sector S having an angle greater than 120°, more preferably over a sector S having an angle greater than 150°, still more preferably over a sector S having an angle greater than 180°.

In further preferred embodiments, numbers and/or shape and/or distribution around the sump axis of the apertures may be different. For example, a preferred embodiment may provide for two apertures, preferably arranged one opposed the other with respect to the sump axis, as for example shown in FIG. 17.

As cited above, a draining circuit 80 is further associated to the sump 40 and is used for discharging liquid to the outside, preferably at the end of a washing program.

The draining circuit 80 comprises a draining pump 180 having an inlet 182 hydraulically communicating with the sump 40 and an outlet 184 hydraulically communicating with an outlet pipe 186 ending outside the cabinet 2.

The draining pump inlet 182 preferably directly communicates with the inner volume 108 of the filtering group 100. The draining pump inlet 182 is preferably connected at the bottom of the sump 40. Advantageously, liquid is efficiently discharged to the outside from sump 40, preferably at the end of a washing program.

The draining pump inlet 182 preferably comprises a connection piece 183, more preferably a tubular connection duct 183, that extends around a connection axis Xd. Sill more preferably the connection piece 183 comprises a tubular cylindrical connection duct 183.

The draining pump inlet 182 is preferably integrally made with the sump 40.

Preferably, the draining pump 180 comprises a suction chamber 188 wherein a rotatable impeller 190 is received. The suction chamber 188 communicates with the bottom of the sump 40 through the draining pump inlet 182. A motor 191 drives the rotatable impeller 190 when necessary.

The suction chamber 188 is preferably defined by a housing 192. For example, as illustrated in the Figures, the draining pump 180 is a centrifugal pump and the housing 192 of the suction chamber 188 is embodied as a volute. Preferably, part of the housing 192 of the suction chamber 188 is integrally formed with the sump 40, more preferably integrally formed with the lateral and bottom walls 44, 46 of the sump 40.

The housing 192 of the suction chamber 188 preferably comprises an inspection aperture 194 that faces the interior of the sump 40 and gives access to the suction chamber 188, as shown in FIG. 11.

According to an aspect of the invention, a removable cover member 200, hereinafter also indicated as pump cover 200, is associated to the inspection aperture 194. The pump cover 200 is preferably associated to the inspection aperture 194 through a snap-in device 210, as better described later.

When removed, a user may have access to the suction chamber 188 and the impeller 190 through the inspection aperture 194 and intervene in case the draining pump 180 gets clogged and cleaning operations are required.

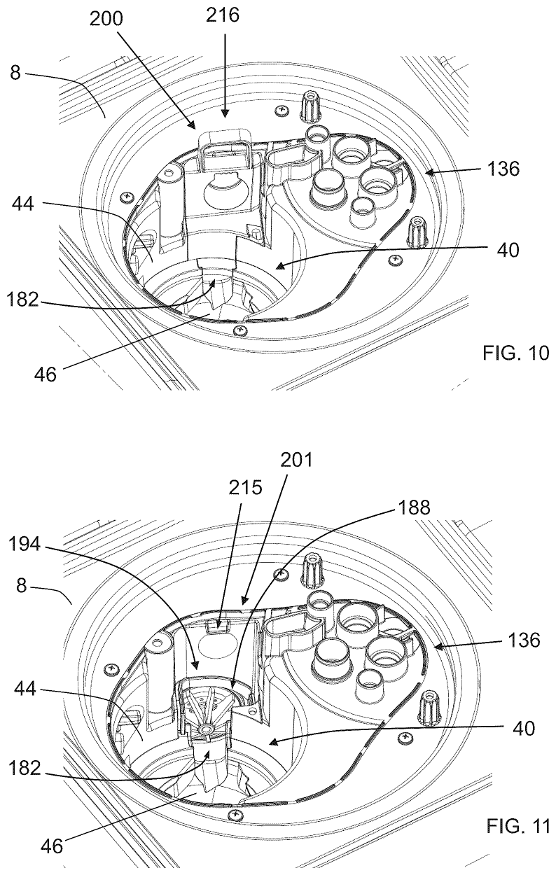

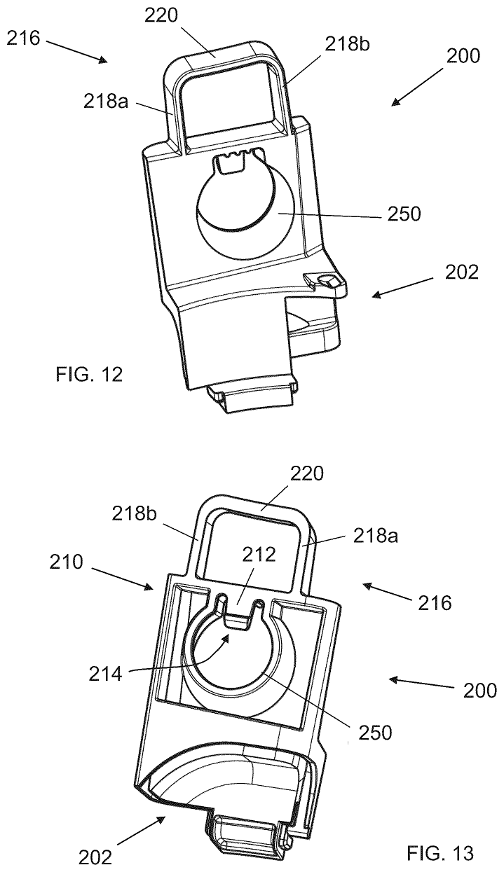

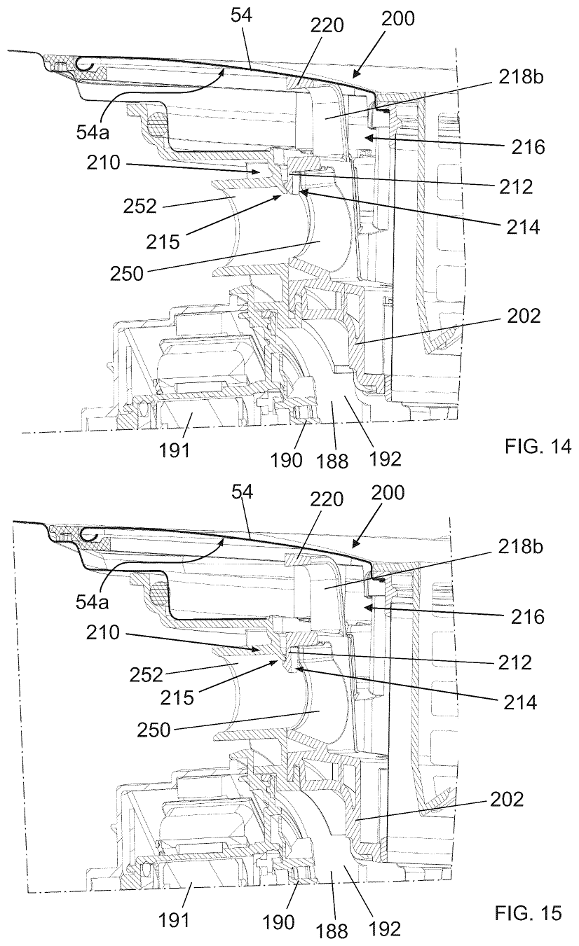

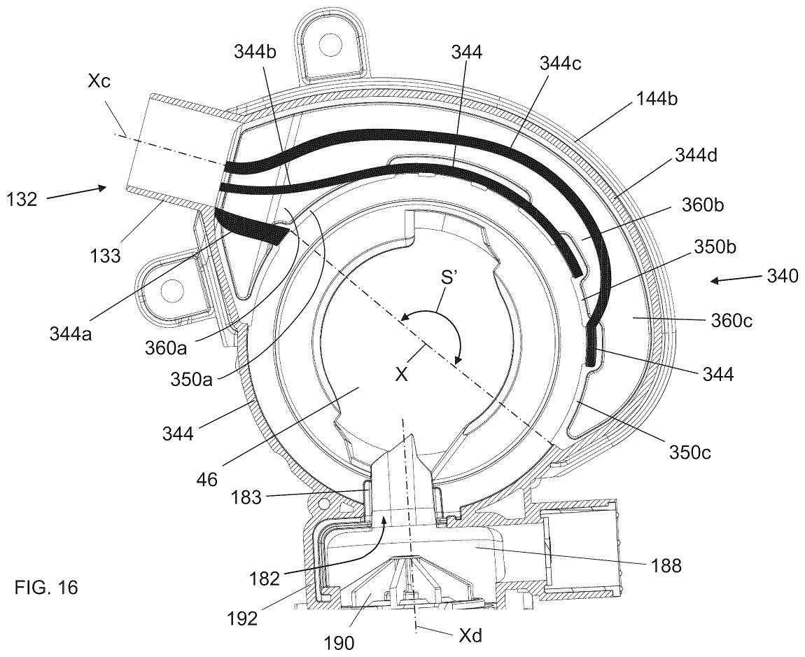

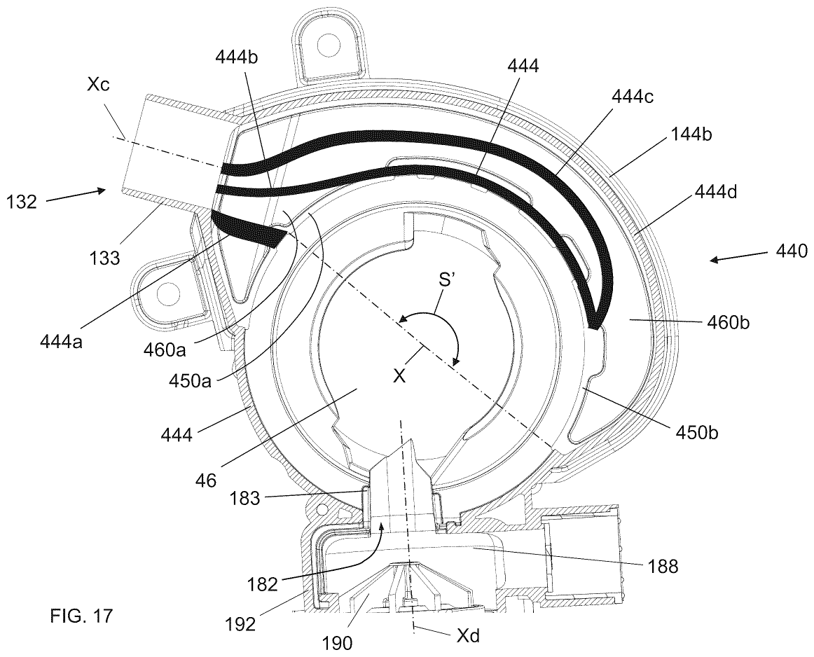

In its working position, as shown in FIG. 10, the pump cover 200 closes the inspection aperture 194 and the draining pump 180 may work normally.

Preferably, the pump cover 200 is removably received in a seat 201 of said sump 40, preferably received in a seat 201 defined at the inner lateral wall 44 of the sump 40.

The pump cover 200 is advantageously accessible to a user from the inside of the sump 40 once the filtering group 100 and the flat filter device 50 have been removed, in particular when at least the second filter 54 is removed.

The pump cover 200 preferably comprises a first portion 202, or lower portion 202, apt to close the inspection aperture 194 when the pump cover 200 is connected to the sump 40.

The pump cover 200 is preferably removably connected to the seat 201 by means of a snap-fit device 210. The snap-fit device 210 preferably comprises an elastic tongue 212 with a protruding tooth 214 arranged at the pump cover 200 and a retaining edge 215 realized in the seat 201 of the sump 40, as illustrated in FIG. 11.

In further preferred embodiments, different connecting devices may be used to removably connecting the pump cover to the seat, for example a screw connection. According to an aspect of invention, the pump cover 200 further comprises a second portion 216, or upper portion 216, preferably embodied as a handle.

The second portion 216 extends from the first portion 202 and towards the flat filter device 50, more preferably extends towards the second flat filter 54.

The second portion 216 preferably comprises two side arms 218a, 218b and a transversal arm 220 connecting the two side arms 218a, 218b.

In a first advantageous aspect thereof, the second portion 216 of the pump cover 200 facilitates handling of the pump cover 200 when the pump cover 200 is removed from the seat 201 or connected to the seat 201.

In a second advantageous aspect thereof, the second portion 216 extends for a predetermined length from the first portion 202 so that the second portion 216 may contact the lower surface of the flat filter device 50, more preferably may contact the lower surface 54a of the second flat filter 54.

Preferably, the second portion 216 of the pump cover 200 contacts the lower surface of the flat filter device 50 when the flat filter device 50 is being positioned in its working position, more preferably contacts the lower surface 54a of the second flat filter 54 when the second flat filter 54 is being positioned in its working position.

Said feature allows the automatic connection of the pump cover 200 to the seat 201 when the flat filter device 50 is placed in its working position, in particular when the second flat filter 54 is placed in its working position.

Preferably, said feature allows the automatic connection of the pump cover 200 to the seat 201 when the filtering group 100 is placed in its working position, being the second flat filter 54 connected to the filtering group 100.

FIG. 14 shows an operating condition wherein the pump cover 200 is arranged over the seat 201 and ready to be positioned in its working position but not yet connected to the seat 201. The lower surface 54a of the second flat filter 54 abuts against the transversal arm 220 of the second portion 216 of the pump cover 200. The filtering group 100 is arranged in the sump 40 but not yet connected thereto. FIG. 15 shows a successive operating condition wherein the second flat filter 54 is placed in its working position. Such operating condition is reached after the filtering group 100 is connected to the sump 40, preferably by pushing downwardly and rotating the filtering group 100 according to bayonet movements. The pushing action on the filtering group 100 is transmitted to the second flat filter 54 which is connected thereto. The lower surface 54a of the second flat filter 54 pushes the transversal arm 220 of the second portion 216 of the pump cover 200 and eventually the engagement of the tooth 214 of the pump cover 200 with the retaining edge 215 of the seat 201.

The filtering group 100, the second flat filter 54 and the pump cover 200 finally reach their respective working positions.

Advantageously, by providing the pump cover 200 with said second portion 216 it is guaranteed that the pump cover 200 is correctly positioned in its working position after the second flat filter 54 is positioned in its working, even in case the user did not properly connect the pump cover 200 into the seat 201 and the pump cover 200 remained disconnected from the seat 201.

The pump cover 200 according to the invention, therefore, makes maintenance operations more reliable compared to known systems.

It has to be noted that the transversal arm 220 of the pump cover 200 is slightly inclined to match inclination of the lower surface 54a of the second flat filter 54 so that contacting surfaces are increased and the pushing action enhanced.

The pump cover 200 is also preferably provided with a through hole 250 that communicates with a supply duct 252 that is used to supply clean water from an external water supply line, not shown. The water supply system of a dishwasher is well known in the art, and therefore it will not be described in detail.

In further preferred embodiments, the supply duct may reach other parts of the sump and/or of the tub and hence the trough hole in the pump cover can be omitted. According to the embodiment described above, the circulating pump 130 is preferably connected to the sump 40 according to a tangential configuration and the draining pump 180 is preferably connected to the sump 40 according to a radial configuration.

The tangential configuration of the circulating pump 130 is defined by the orientation of its inlet 132, more preferably by the orientation of the tubular connection duct 133, in relation to the shape of the sump 40.

In particular, the tubular connection duct 133 is oriented in such a way that the projection towards said sump axis X of the tubular connection duct 133 along a direction parallel to the connection axis Xc, indicated with dashed lines in FIG. 9, does not enclose/encompass the sump axis X or, in other words, said projection of the tubular connection duct 133 is external to the sump axis X.

Advantageously, the circulating pump 130 is mounted in a space-saving manner that reduces encumbrance.

Analogously, the radial configuration of the draining pump 180 is defined by the orientation of its inlet 182, more preferably by the orientation of the tubular connection duct 183, in relation to the shape of the sump 40.

In particular, the tubular connection duct 183 is oriented in such a way that the projection towards the sump axis X of the tubular connection duct 183 along a direction parallel to the connection axis Xd, indicated with dashed lines in FIG. 9, encloses/encompasses the sump axis X.

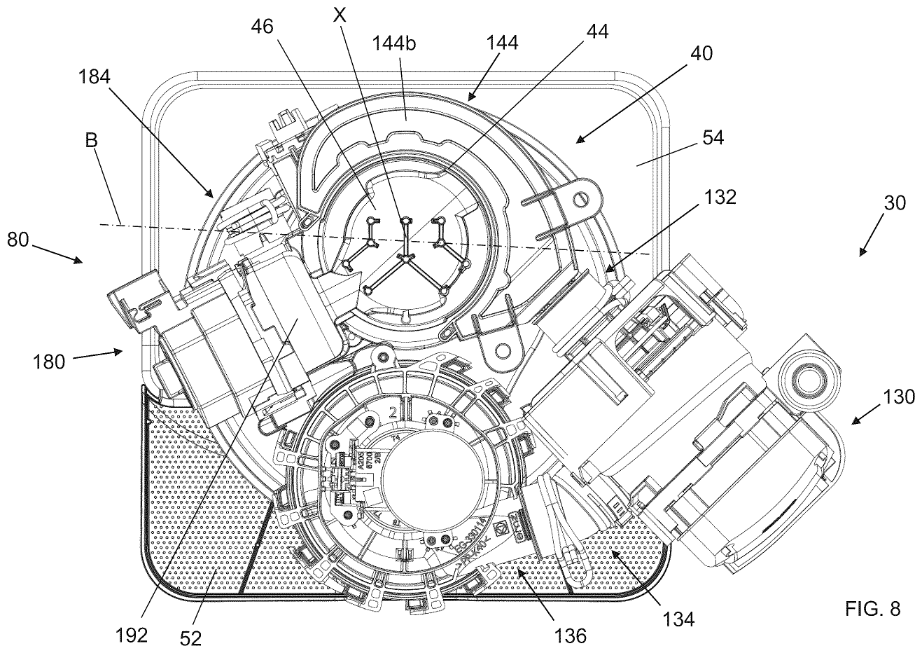

Furthermore, according to the embodiment described above, the circulating pump 130 and the draining pump 180 are preferably both arranged at the same side with respect to a bisecting plane B passing through the sump axis X, as illustrated in FIG. 8.

Advantageously, the pumps 130, 180 are arranged around the sump 40 to optimize the space occupation.

Still advantageously, pumps 130, 180 and related electric motors are arranged at the same side with respect to the bisecting plane B leading to reduced cabling complexity and/or cabling costs.

Furthermore, the circulating pump 130 and the draining pump 180 are preferably both arranged at the same side with respect to the bisecting plane B so that the pumps 130, 180 substantially lay at the rear side of the dishwasher 1. This means, for example, that pumps 130, 180 are arranged at the right of the bisecting plane B, looking at FIG. 8, wherein the right direction is the direction towards the rear side of the dishwasher 1 while the left direction is the direction towards the front side of the dishwasher 1. Advantageously, by providing the pumps 130, 180 at the rear side of the dishwasher 1 the overall noise level is reduced considering a person placed in front of the dishwasher 1.

In the preferred embodiment described above, the sump according to the invention is provided with a single liquid channel and all the apertures of the inner lateral wall of the sump feed the single liquid channel.

In further preferred embodiments, nevertheless, the sump may be provided with two or more liquid channels and one or more apertures of the inner lateral wall of the sump may feed each of said liquid channels.

FIG. 16 represents a section view showing a sump 340 according to an embodiment of this type.

In the drawings, corresponding characteristics and/or components of the embodiment previously described are identified by the same reference numbers.

According to this preferred embodiment, the inner lateral wall 344 of the sump 340 comprises three apertures 350a, 350b, 350c arranged around the sump axis X, wherein the apertures 350a, 350b, 350c hydraulically communicate with the circulating pump inlet 132 through respective separated liquid channels 360a, 360b, 360c.

The liquid channels 360a, 360b, 360c are delimited by the inner lateral wall 344 and further lateral walls 344a, 344b, 344c, 344d of the sump 340, wherein the further lateral walls 344a, 344b, 344c, 344d are external to the inner lateral wall 344. The further lateral walls 344a, 344b, 344c, 344d are preferably integrally made with the sump itself 340.

Preferably, the first liquid channel 360a is delimited by a first further lateral wall 344a and a second further lateral wall 344b; the second liquid channel 360b is delimited by the inner lateral wall 344, the second further lateral wall 344b and a third further lateral wall 344c; the third liquid channel 360c is delimited by the inner lateral wall 344, the third further lateral wall 344c and a fourth further lateral wall 344d.

The further lateral walls 344a, 344b, 344c, 344d preferably extend around the inner lateral wall 344 of the sump 340, more preferably extend around a portion of the inner lateral wall 344.

The further lateral walls 344b, 344c, 344d are preferably curved shaped around the inner lateral wall 344, except for the first further lateral wall 344a that is a substantially straight wall 344a.

A lower portion 144b, as for the first preferred embodiment, is preferably embodied as a separate part and fixedly connected to the further lateral walls 344a, 344b, 344c, 344d, for example through a welding process.

The liquid channels 360b, 360c are therefore preferably delimited by the further lateral walls 344a, 344b, 344c, 344d and the lower portion 144b.

The liquid channels 360b, 360c preferably extend as curved channels around the inner lateral wall 344 of the sump 340, except for the first channel 360a that is a substantially straight channel 360a.

Each liquid channel 360a, 360b, 360c is advantageously fed with liquid through a respective aperture 350a, 350b, 350c, that represents the inlet for the liquid channel 360a, 360b, 360c, and ends at the circulating pump inlet 132 the represents the outlet for each liquid channel 360a, 360b, 360c.

The apertures 350a, 350b, 350c are arranged around the sump axis X to occupy a predetermined sector S′ of circle.

The first aperture 350a is preferably arranged close to the pump inlet 132 and other apertures 350b, 350c are arranged opposite the first aperture 350a with respect the sump axis X. Hence, the sector S′ with said apertures 350a, 350b, 350c preferably has an angle around 180°.

In this preferred embodiment illustrated and described above, the inlet of each liquid channel 360a, 360b, 360c is represented by a single respective aperture 350a, 350b, 350c. In different embodiments, not shown, a liquid channel may be preferably configured to embrace two or more apertures.

FIG. 17 represents a section view showing a sump 440 according to another embodiment of the invention.

In the drawings, corresponding characteristics and/or components of the embodiment previously described with reference to FIG. 16 are identified by the same reference numbers.

According to this preferred embodiment, the inner lateral wall 444 of the sump 440 comprises two apertures 450a, 450b arranged around the sump axis X, wherein the apertures 450a, 450b hydraulically communicate with the circulating pump inlet 132 through respective separated liquid channels 460a, 460b.

The liquid channels 460a, 460b are delimited by further lateral walls 444a, 444b, 444c, 444d of the sump 440, wherein the further lateral walls 444a, 444b, 444c, 444d are external to the inner lateral wall 444 of the sump 440. The further lateral walls 444a, 444b, 444c, 444d are preferably integrally made with the sump itself 440.

Preferably, the first liquid channel 460a is delimited by a first further lateral wall 344a and a second further lateral wall 344b; the second liquid channel 460b is delimited by a third further lateral wall 444c and a fourth further lateral wall 344d. The further lateral walls 444a, 444b, 444c, 444d preferably extend around the inner lateral wall 444 of the sump 440, more preferably extend around a portion of the inner lateral wall 444.

The further lateral walls 444b, 444c, 444d are preferably curved around the inner lateral wall 444, except for the first further lateral wall 444a that is a substantially straight wall 344a. More preferably, the further lateral walls 444b, 444c, 444d are circularly shaped for almost all their extensions.

A lower portion 144b, as for the previous preferred embodiment, is preferably embodied as a separate part and fixedly connected to the further lateral walls 444a, 444b, 444c, 444d, for example through a welding process.

The liquid channels 460b, 460b are therefore preferably delimited by the further lateral walls 444a, 444b, 444c, 444d and the lower portion 144b.

The second liquid channel 460b therefore preferably extends as a curved channel around the inner lateral wall 444 of the sump 440. The first channel 460a is preferably a substantially straight channel 460a.

Each liquid channel 460a, 460b is advantageously fed with liquid through a respective aperture 450a, 450b that represents the inlet for the liquid channel 460a, 460b and ends at the circulating pump inlet 132 the represents the outlet for each liquid channel 460a, 460b.

The two apertures 450a, 450b are arranged around the sump axis X to occupy a predetermined sector S′ of circle.

The first aperture 450a is preferably arranged close to the pump inlet 132 and the second aperture 450b is arranged opposite the first aperture 450a with respect the sump axis X. Hence, the sector S′ with said apertures 450a, 450b preferably has an angle around 180°.

In this preferred embodiment illustrated and described above, the inlet of each liquid channel 460a, 460b is represented by a single respective aperture 450a, 450b. In different embodiments, not shown, a liquid channel may be preferably configured to embrace two or more apertures.

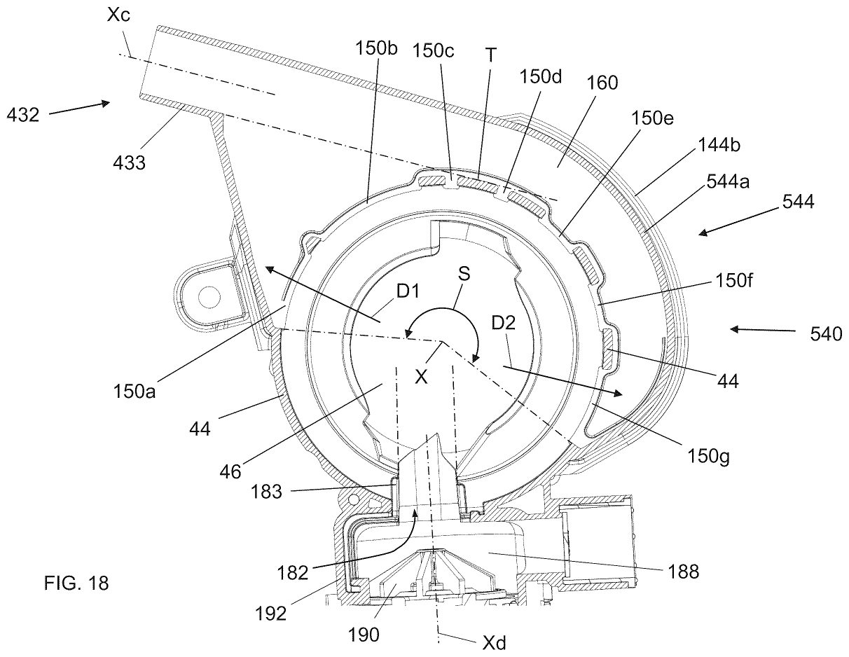

FIG. 18 represents a section view showing a sump 540 according to a further embodiment of the invention.

In the drawings, corresponding characteristics and/or components of the first embodiment previously described with reference to FIGS. 1 to 15 are identified by the same reference numbers. This preferred embodiment differs from the first embodiment in the different orientation of the circulating pump inlet 832, more preferably by the different orientation of the tubular connection duct 833, in relation to the shape of the sump 540.

Here, the further lateral wall 144 is configured so that the tubular connection duct 833 is oriented in such a way that its ideal extension does not enclose/encompass the sump axis X and is preferably tangent, or substantially tangent, the inner lateral wall 44 of the sump 540, as indicated by tangent point T in FIG. 18.

The circulating pump, not shown, is thus still preferably connected to the sump 540 according to a tangential configuration.

It has thus been shown that the present invention allows all the set objects to be achieved. In particular, the invention makes possible to provide a dishwasher that increases the efficiency of the recirculating operations compared to systems of known type.

While the present invention has been described with reference to particular embodiments shown in the figures, it should be noted that the present invention is not limited to the specific embodiments illustrated and described herein; on the contrary, further variants of the embodiments described herein fall within the scope the present invention, which is defined in the appended claims.

1.-20. (canceled)

21. A dishwasher for washing items comprising:
a washing chamber comprising a bottom wall, lateral walls and an aperture for a closing door;
one or more racks for the items to be washed;
at least one spray assembly for spraying liquid onto the items placed in the one or more racks;
a sump arranged at the bottom wall of the washing chamber for receiving liquid from the washing chamber, the sump comprising an inner lateral wall extending around a sump axis (X) and a bottom wall;
a circulating circuit associated to the sump to recirculate liquid from the sump to the at least one spray assembly, wherein the circulating circuit comprises a circulating pump having an inlet hydraulically communicating with the sump;
a filtering group received in the sump and hydraulically arranged upstream the circulating pump for filtering liquid flowing from the sump to the circulating pump;
a draining circuit associated to the sump to drain liquid outside the dishwasher, wherein the draining circuit comprises a draining pump having an inlet hydraulically communicating with the sump;
wherein the inner lateral wall of the sump comprises two or more apertures arranged around the sump axis (X) and hydraulically communicating with the circulating pump inlet through at least one liquid channel, wherein the at least one liquid channel is delimited either by:
a first further lateral wall of the sump and the inner lateral wall, wherein the first further lateral wall is external to the inner lateral wall so that the inner lateral wall is arranged between the first further lateral wall and the sump axis (X); or
a first further lateral wall of the sump and a second further lateral wall of the sump, wherein the first further lateral wall is external to the inner lateral wall and the second further lateral wall is external to the inner lateral wall so that the inner lateral wall is arranged between the first further lateral wall and the sump axis (X) and the first further lateral wall is arranged between the second further lateral wall and the inner lateral wall.

22. The dishwasher of claim 21, wherein the two or more apertures are distributed around the sump axis (X) over a sector (S; S′) having an angle greater than 90°.

23. The dishwasher of claim 21, wherein the two or more apertures have sizes that vary in relation to their position around the sump axis (X).

24. The dishwasher of claim 21, wherein a first aperture of the two or more apertures is arranged close to the circulating pump inlet and a second aperture of the two or more apertures is arranged opposite the first aperture with respect to the sump axis (X).

25. The dishwasher of claim 21, comprising a first aperture of the two or more apertures, a second aperture of the two or more apertures and one or more further apertures arranged between the first and second apertures, wherein the first and second apertures have maximum size and the one or more further apertures decrease in size as the distance between each of the one or more further apertures and the first and second apertures increases.

26. The dishwasher of claim 21, wherein the sector(S) comprises a first sub-sector (S1) and a second sub-sector (S2), wherein the first sub-sector (S1) comprises at least one aperture, having a first size, of the two or more apertures, and the second sub-sector (S2) comprises at least one aperture, having a second size, of the two or more apertures, wherein the first size is greater than the second size.

27. The dishwasher of claim 26, wherein the sector(S) comprises a third sub-sector (S3) comprised between the first sub-sector (S1) and the second sub-sector (S2), wherein the third sub-sector (S3) comprises at least one aperture, having a third size, of the two or more apertures, wherein the third size is less than the first size and/or less than the second size.

28. The dishwasher of claim 21, wherein the two or more apertures feed a single common liquid channel of the at least one liquid channel.

29. The dishwasher of claim 21, wherein the at least one liquid channel comprises a plurality of separated liquid channels and the two or more apertures feed the separated liquid channels.

30. The dishwasher of claim 21, wherein the filtering group comprises at least a filter element, the at least a filter element comprising a tubular filtering surface wherein the tubular filtering surface delimits an inner volume apt to receive liquid coming from the tub.

31. The dishwasher of claim 21, wherein the inner lateral wall of the sump is cylindrically shaped so that the inner lateral wall shows a circular cross-section considering a section plan which is perpendicular to the sump axis (X).

32. The dishwasher of claim 21, wherein the circulating pump inlet comprises a tubular connection duct extending around a connection axis (Xc) and the tubular connection duct is oriented in such a way that the projection towards the sump axis (X) of the tubular connection duct along a direction parallel to the connection axis (Xc) does not enclose the sump axis (X).

33. The dishwasher of claim 21, wherein the draining pump inlet comprises a tubular connection duct extending around a connection axis (Xd) and the tubular connection duct is oriented in such a way that the projection towards the sump axis (X) of the tubular connection duct along a direction parallel to the connection axis (Xd) encloses the sump axis (X).

34. The dishwasher of claim 21, wherein the circulating pump (130) and the draining pump are both arranged at the same side with respect to a bisecting plane (B) passing through the sump axis (X), wherein the side corresponds to the rear side of the dishwasher.

35. A dishwasher for washing items comprising:
a washing chamber comprising a bottom wall, lateral walls and an aperture for a closing door;
at least one spray assembly for spraying liquid onto items placed in one or more racks;
a sump arranged at the bottom wall of the washing chamber for receiving liquid from the washing chamber, the sump comprising an inner lateral wall extending around a sump axis (X) and a bottom wall;
a circulating circuit configured to recirculate liquid from the sump to the at least one spray assembly, wherein the circulating circuit comprises a circulating pump having an inlet hydraulically communicating with the sump;
a filtering group received in the sump and hydraulically arranged upstream the circulating pump for filtering liquid flowing from the sump to the circulating pump;
a draining circuit configured to drain liquid outside the dishwasher, wherein the draining circuit comprises a draining pump having an inlet hydraulically communicating with the sump;
wherein the inner lateral wall of the sump comprises two or more apertures arranged around the sump axis (X) and hydraulically communicating with the circulating pump inlet through at least one liquid channel, wherein the two or more apertures are distributed around the sump axis (X) over a sector (S; S′) having sector angle greater than 90°, and wherein the two or more apertures have sizes that vary in relation to their position around the sump axis (X). and wherein the at least one liquid channel is delimited either by:
a first further lateral wall of the sump and the inner lateral wall, wherein the first further lateral wall is external to the inner lateral wall so that the inner lateral wall is arranged between the first further lateral wall and the sump axis (X); or
a first further lateral wall of the sump and a second further lateral wall of the sump, wherein the first further lateral wall is external to the inner lateral wall and the second further lateral wall is external to the inner lateral wall so that the inner lateral wall is arranged between the first further lateral wall and the sump axis (X) and the first further lateral wall is arranged between the second further lateral wall and the inner lateral wall.

36. The dishwasher of claim 35, wherein the sector angle is greater than 120°.

37. The dishwasher of claim 36, wherein the sector angle is greater than 150°.

38. A dishwasher for washing items comprising:
a washing chamber comprising a bottom wall, lateral walls and an aperture for a closing door;
at least one spray assembly configured to spray liquid;
a sump arranged at the bottom wall of the washing chamber for receiving liquid from the washing chamber, the sump comprising an inner lateral wall extending around a sump axis (X) and a bottom wall;
a circulating circuit associated to the sump to recirculate liquid from the sump to the at least one spray assembly, wherein the circulating circuit comprises a circulating pump having an inlet hydraulically communicating with the sump;
a filtering group received in the sump and hydraulically arranged upstream the circulating pump for filtering liquid flowing from the sump to the circulating pump;
a draining circuit associated to the sump to drain liquid outside the dishwasher, wherein the draining circuit comprises a draining pump having an inlet hydraulically communicating with the sump;
wherein the inner lateral wall of the sump comprises first and second apertures arranged around the sump axis (X) and hydraulically communicating with the circulating pump inlet through at least one liquid channel, wherein the second aperture is arranged opposite the first aperture with respect to the sump axis (X), and wherein the at least one liquid channel is delimited either by:
a first further lateral wall of the sump and the inner lateral wall, wherein the first further lateral wall is external to the inner lateral wall so that the inner lateral wall is arranged between the first further lateral wall and the sump axis (X); or
a first further lateral wall of the sump and a second further lateral wall of the sump, wherein the first further lateral wall is external to the inner lateral wall and the second further lateral wall is external to the inner lateral wall so that the inner lateral wall is arranged between the first further lateral wall and the sump axis (X) and the first further lateral wall is arranged between the second further lateral wall and the inner lateral wall.

39. The dishwasher of claim 38, wherein the first aperture is arranged closer to the circulating pump inlet than the second aperture.

40. The dishwasher of claim 38, wherein the first and second apertures have sizes that vary in relation to their respective positions around the sump axis (X).
